(19) United States
(12) Patent Application Publication
(10) Pub. No.: US 2025/0207992 A1
(43) Pub. Date: Jun. 26, 2025

(54) PIPELINE FLUID PRESSURE FLUCTUATION SENSING DEVICE

(71) Applicant: Industrial Technology Research Institute, Hsinchu (TW)

(72) Inventors: YAW-MING CHEN, Hsinchu City (TW); CHAO-JEN LI, Hsinchu-City (TW); CHU-CHUNG HSIAO, Hsinchu City (TW)

(21) Appl. No.: 18/391,708

(22) Filed: Dec. 21, 2023

(51) Int. Cl. G01L 23/14; G01L 19/06; G01L 23/26

(52) U.S. Cl. CPC G01L 23/14; G01L 19/0618; G01L 23/26

(57) ABSTRACT

A pipeline fluid pressure fluctuation sensing device includes a housing, vibrating membrane, fixing ring, pressure balance hole, magnetic element, and magnetic sensing element. The housing includes an open end and closed end opposite to each other, so that no conducting wire is passed through the housing; the open end is used to connect the fluid pipeline. The vibrating membrane is provided inside the housing, and the vibrating membrane is allowed to be displaced due to the pressure change generated from fluid pipeline. The fixing ring is connected between the housing and vibrating membrane. The pressure balance hole is passed through the fixing ring and used to balance pressure at the two opposite sides of the vibrating membrane. The magnetic element and vibrating membrane are linked to each other, where the magnetic element is generated with a displacement change due to the displacement of the vibrating membrane.

### TECHNICAL FIELD

The present invention relates to a sensing device adapted to sense pipeline fluid pressure fluctuation.

### BACKGROUND

The transportation safety of industrial flammable fluids is a very important issue, and it is necessary to apply sensing technology to monitor pipeline leakage to avoid life, property, and economic losses caused by pipeline leakage.

Generally speaking, different types of sensors, such as pressure sensors and acoustic wave sensors, are commonly used to detect pressure changes and sound wave propagation caused by pipeline leakage, and are used to monitor pipeline leakage.

In the conventional design of these sensors, the sensing element and circuit are placed in the sensor housing, and then wires are passed through the housing to connect to the outer measurement device. The circuit is located in the flammable fluid in the sensor housing, or there are wires crossing the pressure boundary, which may cause leakage in the long term. These factors lead to doubts about the safety of operations in flammable fluid environments.

Conventional designs of pressure sensors use membrane deformation to sense pressure, but the membrane is also a part of the pressure boundary, and is a weaker structural part in the pressure boundary relative to the housing.

In addition, the pressure sensing diaphragm must have sufficient strength because it needs to withstand fluid pressure, which also affect the measure of small pressure changes.

### SUMMARY

The present invention provides a pipeline fluid pressure fluctuation sensing device to monitor transmission pipeline leaks to avoid industrial safety accidents.

An embodiment of the present invention proposes a pipeline fluid pressure fluctuation sensing device adapted to connect a fluid pipeline and including a housing, vibrating membrane, fixing ring, pressure balance hole, magnetic element, and magnetic sensing element. The housing includes an open end and closed end opposite to each other, and there is no circuit between the open end and closed end so that no conducting wire is passed through the housing; the open end is used to connect the fluid pipeline. The vibrating membrane is provided inside housing, and the vibrating membrane is allowed to be displaced due to the pressure change generated from the fluid pipeline. The fixing ring is connected between the housing and vibrating membrane. The pressure balance hole is used to balance pressure at the two opposite sides of the vibrating membrane. The magnetic element and vibrating membrane are linked to each other, where the magnetic element is generated with a displacement change due to the displacement of the vibrating membrane. The magnetic sensing element is provided outside the housing, and the magnetic sensing element senses the displacement change of the magnetic element.

Basing on the above, the present invention uses the magnetic field detection principle, the pressure fluctuation drives the vibrating membrane in the housing, the magnetic element is generated with a displacement change because of the displacement of the vibrating membrane, and the magnetic sensing element senses the displacement change of the magnetic element, which is converted into an electric signal by the magnetic sensing element.

Furthermore, the background pressure at the two sides of the disclosed vibrating membrane is balanced through the pressure balance hole, capable of improving the sensitivity of the pressure fluctuation measurement in a high-pressure environment.

Furthermore, the present invention has no conducting wire passed through the housing, having an intact pressure boundary, without the risk of long-term leakage, and the pressure boundary is not used for sensing, thereby improving the entire strength of the pipeline fluid pressure fluctuation sensing device.

Furthermore, the disclosed housing includes no circuit element inside, thereby Improving the explosion-proof safety of the pipeline fluid pressure fluctuation sensing device in flammable fluid environments.

### BRIEF DESCRIPTION OF THE DRA WINGS

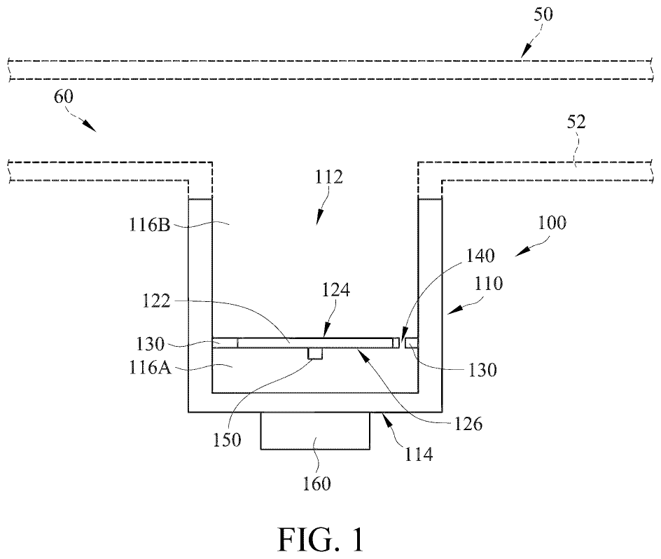

FIG. 1 is a schematic view of an embodiment of a pipeline fluid pressure fluctuation sensing device of the present invention;

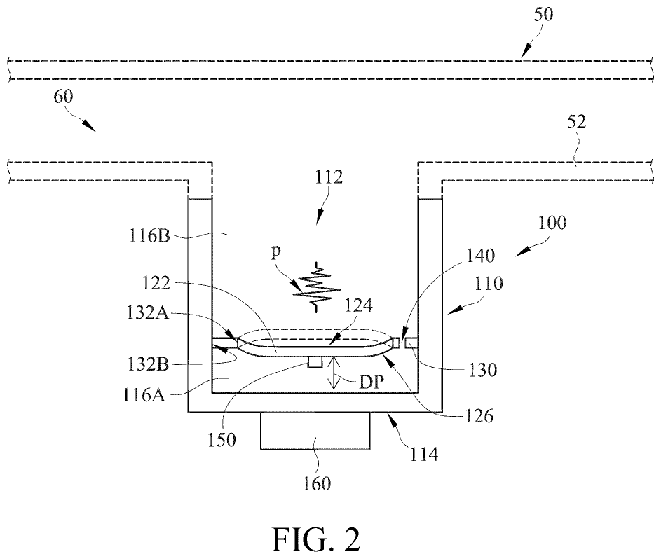

FIG. 2 is a schematic view of an embodiment of the vibrating membrane displacement in the pipeline fluid pressure fluctuation sensing device of FIG. 1;

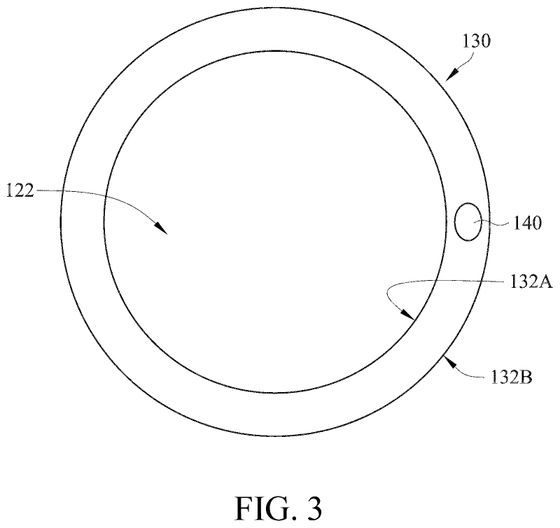

FIG. 3 is a schematic view of an embodiment of a pressure balance device of the present invention;

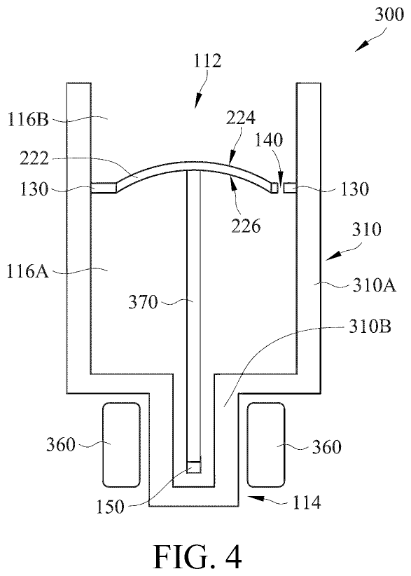

FIG. 4 is a schematic view of another embodiment of a pipeline fluid pressure fluctuation sensing device of the present invention;

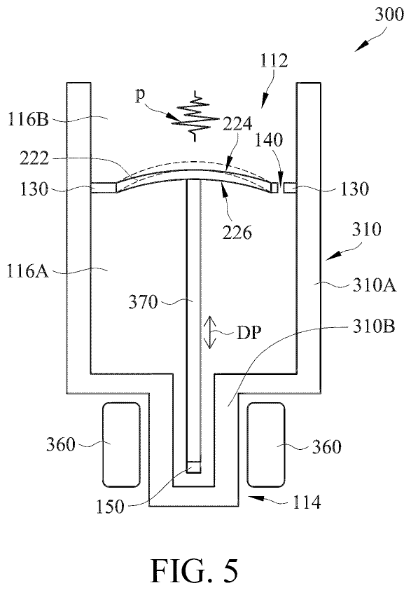

FIG. 5 is a schematic view of an embodiment of the displacement of a vibrating membrane in the pipeline fluid pressure fluctuation sensing device of FIG. 4;

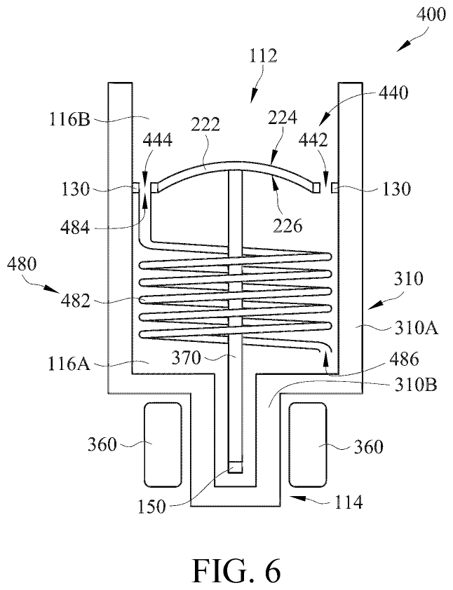

FIG. 6 is a schematic view of yet another embodiment of a pipeline fluid pressure fluctuation sensing device of the present invention;

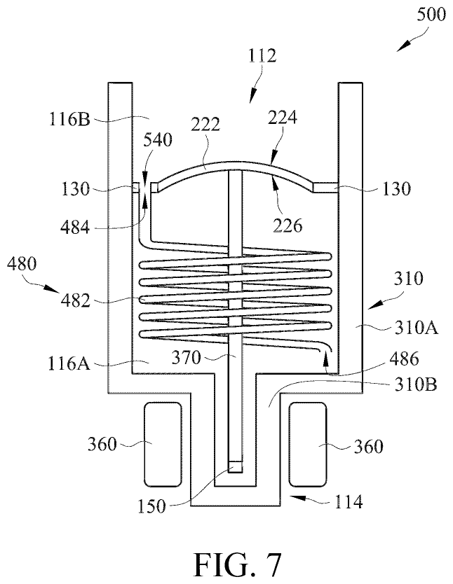

FIG. 7 is a schematic view of a variant embodiment of a pipeline fluid pressure fluctuation sensing device of the present invention;

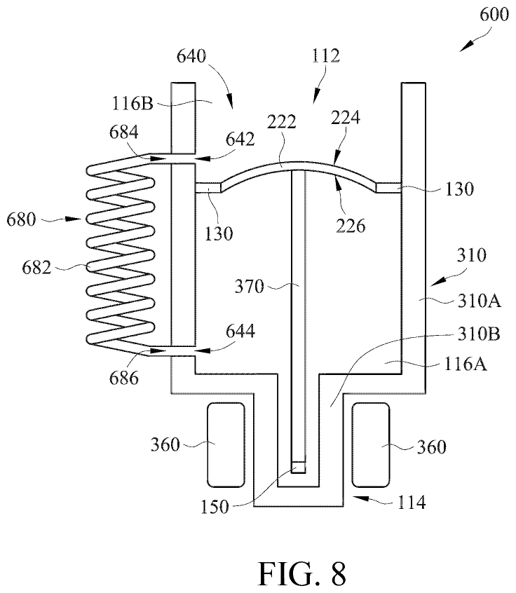

FIG. 8 is a schematic view of other embodiment of a pipeline fluid pressure fluctuation sensing device of the present invention;

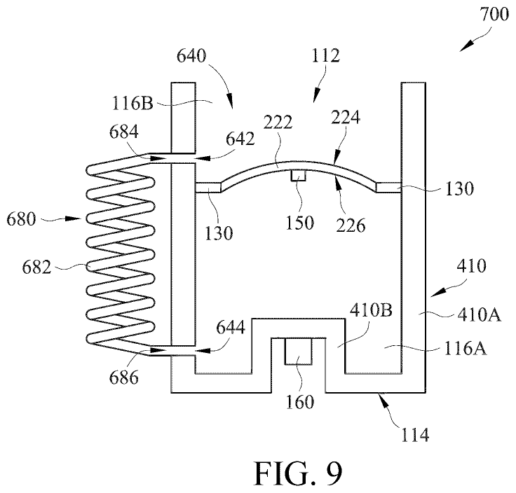

FIG. 9 is schematic view of other variant embodiment of a pipeline fluid pressure fluctuation sensing device of the present invention;

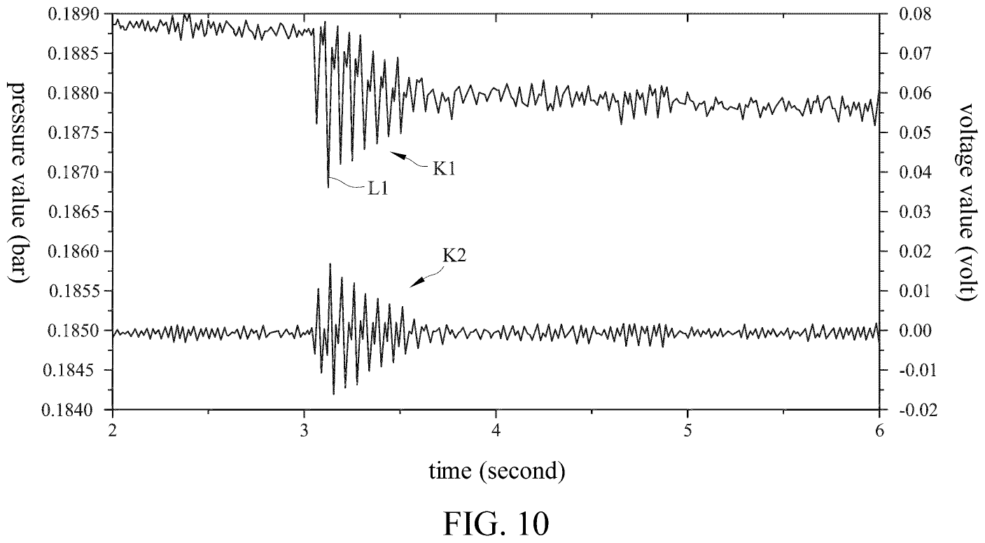

FIG. 10 is a test result of a pipeline fluid pressure fluctuation sensing device of the present invention; and

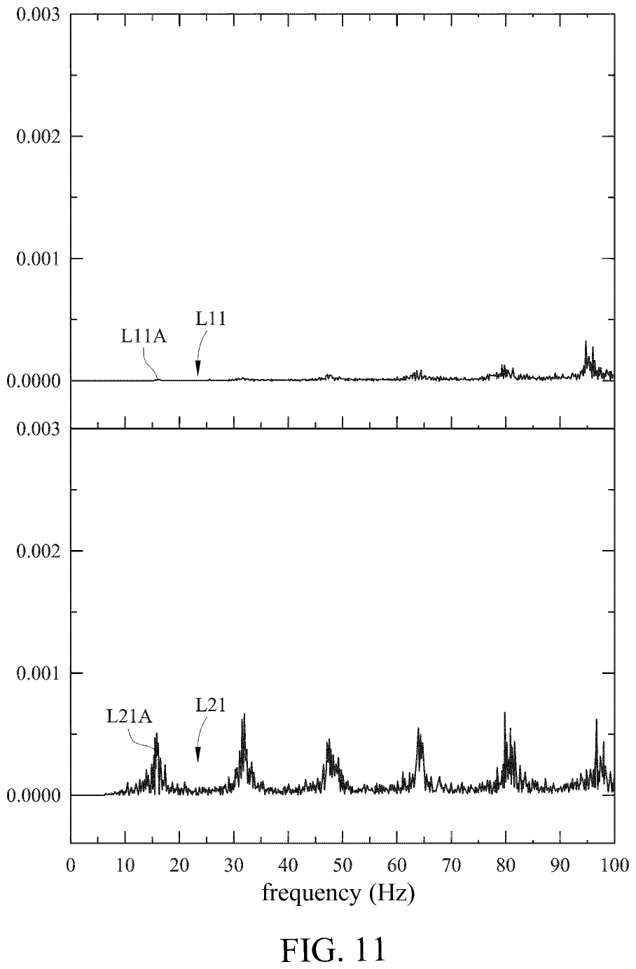

FIG. 11 is a spectrum analysis diagram of a tested fluctuation signal of a pipeline fluid pressure fluctuation sensing device of the present invention.

### DETAILED DESCRIPTION

The following embodiments are enumerated and described in detail with reference to the accompanying drawings, but the provided embodiments are not intended to limit the scope of the present disclosure. In addition, the drawings are for illustrative purposes only and are not drawn to original size. To facilitate understanding, the same elements will be identified with the same symbols in the following description.

The terms “including”, “comprising”, “having”, etc. mentioned in this disclosure are all open terms, that is, they mean “including but not limited to”.

In the description of various embodiments, when terms such as “first”, “second”, “third”, “fourth”, etc. are used to describe elements, they are only used to distinguish these elements from each other, and There is no restriction on the order or importance of these elements.

In the description of various embodiments, the so-called “coupling” or “connection” may refer to two or more elements directly making physical or electrical contact with each other, or indirectly making physical or electrical contact with each other. “Coupling” or “connection” can also refer to the mutual operation or action of two or more elements.

FIG. 1 is a schematic view of a preferred embodiment of a pipeline fluid pressure fluctuation sensing device of the present invention. FIG. 2 is a schematic view of a preferred embodiment of a vibrating membrane displacement in the pipeline fluid pressure fluctuation sensing device of FIG. 1. Referring to FIGS. 1 and 2, a pipeline fluid pressure fluctuation sensing device 100 of the present invention is adapted to connect a fluid pipeline 50, where the fluid pipeline 50 is shown in dotted lines, and may be a hydrogen transportation pipeline, a related process pipeline system using hydrogen, and a petrochemical pipeline system. Inner fluid 60 of the fluid pipeline 50 may be liquid flow, gas flow, or two-phase flow in which gas and liquid exist simultaneously.

The pipeline fluid pressure fluctuation sensing device 100 includes a housing 110, a vibrating membrane 122, a fixing ring 130, a pressure balance hole 140, a magnetic element 150, and a magnetic sensing element 160, where the material of the housing 110 may be non-ferromagnetic metal, non-magnetic material or non-metal that does not affect the magnetic field. Furthermore, the housing 110 may be any shape, and includes an open end 112 and closed end 114 opposite to each other. For example, the housing 110 is a cylindrical housing, the opening at one end of which is defined as the open end 112, and the bottom of the cylindrical housing is defined as the closed end 114. No circuit exists between the open end 112 and closed end 114, which also means that no conducting wire is passed through the housing 110, and the open end 112 is used to connect a pipe wall 52 in the fluid pipeline 50. Furthermore, the connection method between the housing 110 and the fluid pipeline 50 is a flange, screw threads or a common connection method for general pipelines.

The vibrating membrane 122 is provided inside the housing 110, and the material of the vibrating membrane 122 includes an elastomeric structure, a Teflon structure, or a metal structure that can adjust the vibrating membrane 122 depending on a practical situation. The shape of the vibrating membrane 122 is not limited to a flat shape; one side of the vibrating membrane 122 is an outer membrane surface 124, and another side thereof is an inner membrane surface 126; and the vibrating membrane 122 divides the housing 110 into an inner area 116A and an outer area 116B. The vibrating membrane 122 is displaced due to fluctuations in the pressure P (as shown in FIG. 2) generated in the fluid pipeline 50, where the dotted and solid lines are used to indicate that the vibrating membrane 122 vibrates up and down due to the fluctuations in the pressure P.

The fixing ring 130 is connected between the housing 110 and vibrating membrane 122; the pressure balance hole 140 is passed through the fixing ring 130 and used to balance the pressure at the two opposite sides of the outer membrane surface 124 and inner membrane surface 126. In other embodiments, the pressure balance hole may also be two holes on the housing, where one of the holes is in communication with the outer area 116B, and another one thereof inner area 116A.

The magnetic element 150 is provide below the inner membrane surface 126 of the vibrating membrane 122 but may also be provided above the outer membrane surface 124, allowing the magnetic element 150 to be moved with the vibrating membrane 122, where the magnetic element 150 may be a magnet, ferromagnetic metal, or any magnetically conductive element. The magnetic sensing element 160 is provided outside the housing 110 and may include a coil, which may be in the form of a magnetoelectric or eddy current sensor, adapted to sense the magnetic field change caused by the displacement change DP of the magnetic element 150 inside the housing 110.

With the above configuration, as shown in FIG. 2, the vibrating membrane 122 is displaced due to the pressure P (as shown in FIG. 2) fluctuation generated in the fluid pipeline 50, and the magnetic element 150 is also generated with a displacement change DP because the vibrating membrane 122 is displaced. Thereafter, the magnetic sensing element 160 senses the displacement change DP of the magnetic element 150, which is converted into an electric signal by the magnetic sensing element 160. Furthermore, the background pressure of the outer membrane surface 124 and inner membrane surface 126 of the vibrating membrane 122 is balanced by the pressure balance hole 140, which can improve the sensitivity of the pressure fluctuation measurement in a high-pressure environment.

Furthermore, the present invention has no conducting wire passed through the housing 110, having a complete pressure boundary, and has no risk of long-term leakage, and the pressure boundary is not used for sensing, thereby increasing the entire strength of the pipeline flow pressure fluctuation sensing device.

In addition, no circuit element is included inside the housing 110 of the present invention, which improves the explosion-proof safety of the pipeline fluid pressure fluctuation sensing device 100 in flammable fluid environments.

FIG. 3 is a schematic view of a preferred embodiment of a pressure balance device of the present invention. Referring to FIGS. 2 and 3, the fixing ring 130 is, for example, an annular body, so that it can be an annular bearing seat. Furthermore, the fixing ring 130 has an inner peripheral surface 132A and outer peripheral surface 132B, where the outer peripheral surface 132B is installed and fixed on the inner surface of the housing 110, and there are holes inside the inner peripheral surface 132A; the vibrating membrane 122 is connected inside the inner peripheral surface 132, allowing the vibrating membrane 122 to be installed inside the inner peripheral surface 132 of the fixing ring 130. The pressure balance hole 140 is passed through between the inner peripheral surface 132A and outer peripheral surface 132B of the fixing ring 130

FIG. 4 is a schematic view of yet another preferred embodiment of a pipeline fluid pressure fluctuation sensing device of the present invention. FIG. 5 is a schematic view of a preferred embodiment of a vibrating membrane displacement in the pipeline fluid pressure fluctuation sensing device of FIG. 4. Referring to FIGS. 4 and 5, the difference between a pipeline fluid pressure fluctuation sensing device 300 of the present embodiment and the pipeline fluid pressure fluctuation sensing device 100 of FIG. 1 is that the pipeline fluid pressure fluctuation sensing device 300 of the present embodiment further includes an extension rod 370, and a housing 310 and magnetic sensing element 360 in relation to the configuration of the extension rod 370.

In detail, the vibrating membrane 222 includes an outer membrane surface 224 and inner membrane surface 226 opposite to each other; the extension rod 370 is connected between the vibrating membrane 222 and magnetic element 150, allowing the vibrating membrane 222, extension rod 370 and magnetic element 150 to be formed into a linkage component, so that the displacement of the vibrating membrane 222 will move the extension rod 370 to move with it, thereby causing the displacement of the magnetic element 150. In respond to the configuration of the extension rod 370, the housing 310 includes a main body 310A and an extension body 310B, where the extension body 310B is in communication with the main body 310A. The material of the housing 310 may be non-ferromagnetic metal, non-magnetic material or non-metal that do not affect the magnetic field. A part of the magnetic element 150 and extension rod 370 is positioned inside the extension body 310B. The extension body 310B is a protruding accommodation space connected below the main body 310, and the type thereof depends on the length of the extension rod 370. In other preferred embodiments, if the length of the extension rod is adjusted, the extension body 310B does also not need to be configured, allowing the extension rod 370 to be only positioned inside the main body 310A.

In an embodiment, the extension rod 370 is a rod or other component having equivalent functions. The material of the extension rod 370 may be a non-magnetic material. In other embodiments, the extension rod 370 may also be made of magnetic material.

In addition, the magnetic sensing element 360 is positioned outside the extension body 310B, and the magnetic sensing element 360 is, for example, an annular body structure. With the configuration of the extension rod 370, the magnetic element 150 is provided on one end of the extension rod 370 away from the vibrating membrane 222, allowing the magnetic element 150 to be close to the magnetic sensing element 360, allowing the magnetic sensing element 360 to better sense the displacement change of the magnetic element 150.

In this configuration, as shown in FIG. 5, the dotted lines show the position of the vibrating membrane 222. The vibrating membrane 222 is caused to be displaced due to the pressure P fluctuation of the fluid pipeline, and the extension rod 370 and the magnetic element 150 on the end thereof are also moved the displacement change DP because of the displacement of the vibrating membrane 222. Thereafter, the magnetic sensing element 360 senses the displacement change DP of the magnetic element 150, and the displacement change DP is converted into an electric signal by the magnetic sensing element 360.

FIG. 6 is a schematic view of yet another embodiment of the pipeline fluid pressure fluctuation sensing device of the present invention. Referring to FIG. 6, the difference between a pipeline fluid pressure fluctuation sensing device 400 of the present embodiment and the pipeline fluid pressure fluctuation sensing device 300 of FIGS. 4 and 5 is that the pipeline fluid pressure fluctuation sensing device 400 of the present embodiment further includes a low-frequency extension tube 480 adapted to measure pressure fluctuations at low frequencies (such as the subsonic range below 20 Hz), and a pressure balance hole 440 related to the low-frequency extension tube 480.

The low-frequency extension tube 480 is provided inside the housing 310, and positioned in the inner area 116A in the main body 310A. The low-frequency extension tube 480 includes a tube body 482, an entrance end 484, and an exit end 486. The pressure balance holes 440 numbers 2, including a first pressure balance hole 442 and second pressure balance hole 444. The fixing ring 130 is connected between the housing 310 and vibrating membrane 222, and the first pressure balance hole 442 and second pressure balance hole 444 are respectively passed through the different positions of the fixing ring 130, where the second pressure balance hole 444 is in communication with the entrance end 484 of the low-frequency extension tube 480, allowing the tube body 482 to be connected to the fixing ring 130. The first pressure balance hole 442 is not in communication with the tube body 482, the position and functions thereof can be regarded as the position and functions of the above pressure balance hole 140 of FIGS. 1 to 5.

Under the above configuration, the low-frequency extension tube 480 and first pressure balance hole 442, in this embodiment, coexist on the same pipeline fluid pressure fluctuation sensing device 400. In use, one of the first pressure balance hole 442 and second pressure balance hole 444 may be chosen to apply, for example, the second pressure balance hole 444 is closed, the functions and operation principle are similar to FIG. 5 mentioned above, or for example, the first pressure balance hole 442 is closed, the low-frequency extension tube 480 is used to measure pressure fluctuations at low frequencies (such as the subsonic range below 20 Hz), allowing the pipeline fluid pressure fluctuation sensing device 400 of the present embodiment to cover the fluctuation frequency range to the subsonic range (below 20 HZ), capable of effectively measuring and catching low-frequency fluctuations. In addition, the two ends of the low-frequency extension tube 480 are the two end openings of the entrance end 484 and exit end 486, and the second pressure balance hole 444 is used to be in communication with the entrance end 484 of the low-frequency extension tube 480, which can also balance the pressure at the two sides of the vibrating membrane 222.

In an embodiment, the low-frequency extension tube 480 is based on the principle of Helmholtz resonance, and the effect thereof depends on the tube diameter and tube length. The equation (1) of Helmholtz resonance is as follows:

$$The resonance frequency f = \frac{v}{2 π} \sqrt{\frac{A}{VL}} . \qquad ( 1 )$$

In the above equation (1), v is the sound speed; A is the cross-sectional area of the tube body 482 that can be obtained by calculating the tube diameter of the tube body 482; L is the tube length of the tube body 482; and V is the cavity volume, which is the volume of the area below the vibrating membrane 222, taking the housing 310 as an example.

In an embodiment, the tube body 482 may be a spiral pipe. The tube body 482 is arranged around the outer periphery of the extension rod 370, and avoids the extension rod 370 through the spiral configuration shape, so that the extension rod 370 can still move in the center of the tube body 482 and can be used to reduce the length of the tube body 482 in the longitudinal direction to allow the tube body 482 to be accommodated in the housing 310, thereby improving the convenience of use. In other embodiments, the tube body 482 can be other configuration type according to the shape and size of the housing body 310.

FIG. 7 is a schematic view of a variant embodiment of a pipeline fluid pressure fluctuation sensing device of the present invention. Referring to FIG. 7, the difference between a pipeline fluid pressure fluctuation sensing device 500 of the present embodiment and the pipeline fluid pressure fluctuation sensing device 400 of FIG. 6 is that the pipeline fluid pressure fluctuation sensing device 500 of the present embodiment only has one pressure balance hole 540, which is in communication with the entrance end 484 in the low-frequency extension tube 480.

FIG. 8 is a schematic view of other embodiment of a pipeline fluid pressure fluctuation sensing device of the present invention. Referring to FIG. 8, the difference between a pipeline fluid pressure fluctuation sensing device 600 of the present embodiment and the pipeline fluid pressure fluctuation sensing device 500 of FIG. 7, the pipeline fluid pressure fluctuation sensing device 400 of FIG. 6 is that a low-frequency extension tube 680 in the pipeline fluid pressure fluctuation sensing device 600 of the present embodiment is provided outside the housing 310, and a correspondingly provided pressure balance hole 640 includes a first pressure balance hole 642 and a second pressure balance hole 644. Different from the above embodiments, the fixing ring 130 of the present embodiment is connected between the housing 310 and vibrating membrane 122, but the pressure balance hole 640 is not passed through the fixing ring 130, making the fixing ring 130 have no pressure balance hole. Instead, the first pressure balance hole 642 and second pressure balance hole 644 are respectively passed through a different position of the housing 310, and the first pressure balance hole 642 is positioned on the outer area 116B, and the second pressure balance hole 644 the inner area 116A.

A low-frequency extension tube 680 includes a tube body 682, entrance end 684 and exit end 686, where the tube body 682 may be a spiral tube, the entrance end 684 is in communication with the first pressure balance hole 642 in the outer area 116B, and the exit end 686 the second pressure balance hole 644 in the inner area 116A. In this way, the background pressure at both sides of the vibrating membrane 222 is balanced through the first pressure balance hole 642 and the second pressure balance hole 644, and the low-frequency extension tube 680 is used to measure pressure fluctuations at low frequencies (e.g. subsonic range below 20 Hz). In other embodiments, the pressure balance hole may also be passed through the fixing ring 130 to selectively adapt to the aforementioned first pressure balance hole 642 and second pressure balance hole 644.

FIG. 9 is a schematic view of other variant embodiment of a pipeline fluid pressure fluctuation sensing device of the present invention. Referring to FIG. 9, the difference between a pipeline fluid pressure fluctuation sensing device 700 of the present embodiment and the pipeline fluid pressure fluctuation sensing device 600 of FIG. 8 is that the present embodiment has no extension rod, and the magnetic element 150 is provided below the inner membrane surface 226 of the vibrating membrane 222. Furthermore, since the extension rod does not need to be accommodated, the housing 410, for example, includes a main body 410A and a recessed body 410B, where the recessed body 410B is an accommodation space formed inwardly at the bottom of the main body 410A, allowing the magnetic sensing element 160 to be provided inside the recessed body 410B but still positioned outside the main body 410A. Since the recessed body 410B is recessed toward the inside of the main body 410A, the magnetic sensing element 160 is allowed to be closer to the magnetic element 150, so that it can better sense the displacement change of the magnetic element 150. However, the present invention is not limited to this, and the shape of the housing 410 can be adjusted depending on the actual use of the magnetic element 150 and the magnetic sensing element 160 to ensure that the magnetic sensing element 160 can sense the magnetic element 150. Therefore, in other embodiment, the housing 110 shown in FIG. 1 can also be used.

FIG. 10 is a test verification of a pipeline fluid pressure fluctuation sensing device of the present invention, where the horizontal axis represents time in seconds, the left vertical axis represents pressure value in bar, and the right vertical axis represents the voltage value measured by the disclosed pipeline fluid pressure fluctuation sensing device in volts. Referring to FIG. 10, in order to verify the response of the disclosed pipeline fluid pressure fluctuation sensing device to pressure fluctuation, the disclosed pipeline fluid pressure fluctuation sensing device is connected to a 2-inch low-pressure pipeline in air flow for testing. When the time in FIG. 10 is 3 seconds, the operation of the valve on the low-pressure pipeline creates a pressure fluctuation. This fluctuation is shown in the curve K1 in FIG. 10, and the maximum amplitude L1 is 0.002 bar; the response of the disclosed pipeline fluid pressure fluctuation sensing device under the above-mentioned pressure fluctuation is shown in the curve K2. The peaks and troughs of the signal of the curve K2 are consistent with the pressure fluctuation of the curve K1. This result shows that the disclosed pipeline fluid pressure fluctuation sensing device is indeed effective in measuring small pressure fluctuations in a pressure environment, and demonstrates the feasibility of the disclosed pipeline fluid pressure fluctuation sensing device.

FIG. 11 is a spectrum analysis diagram of the fluctuation signal tested and verified by the disclosed pipeline fluid pressure fluctuation sensing device, where the horizontal axis represents frequency in Hertz (Hz), and the vertical axis has no unit. Referring to FIG. 11, this embodiment takes the pipeline fluid pressure fluctuation sensing device 400 of FIG. 6 as a test; the curve L1 of the upper half of FIG. 11 is the result of closing the second pressure balance hole 444 (i.e. the entrance end 484 of the low-frequency extension tube 480) and only opening the first pressure balance hole 442. The curve L21 of the lower half of FIG. 11 is the result of closing the first pressure balance hole 442, opening the second pressure balance hole 444, and allowing the entrance end 484 of the low-frequency extension tube 480 to be opened. Comparing these two curves L11, L21, and the peak values L11A, L21A corresponding to 15 Hz, it can be found that the use of low-frequency extension tube 480 can significantly improve the response below 100 Hz to the subsonic range. In other test conditions, the low-frequency extension tube 480 can detect tiny pressure fluctuations of 13 Hz and 10 Hz. It is obvious that the disclosed pipeline fluid pressure fluctuation sensing device can indeed cover the fluctuation frequency range to the subsonic range.

Conclusively, the present invention uses the magnetic field detection principle, the pressure fluctuation drives the vibrating membrane in the housing, the magnetic element is generated with a displacement change because of the displacement of the vibrating membrane, and the magnetic sensing element senses the displacement change of the magnetic element, which is converted into an electric signal by the magnetic sensing element.

Furthermore, the background pressure at the two sides of the disclosed vibrating membrane is balanced through the pressure balance hole, capable of improving the sensitivity of the pressure fluctuation measurement in a high-pressure environment.

Furthermore, the present invention has no conducting wire passed through the housing, having a complete pressure boundary, and the pressure boundary is not used for sensing, without the risk of long-term leakage, thereby improving the entire strength of the pipeline fluid pressure fluctuation sensing device.

Furthermore, the disclosed housing includes no circuit element inside, thereby Improving the explosion-proof safety of the pipeline fluid pressure fluctuation sensing device in flammable fluid environments.

Furthermore, the present invention measures the pressure fluctuations of low frequencies (the subsonic range below 20 Hz), allowing the disclosed pipeline fluid pressure fluctuation sensing device to cover fluctuation frequency range to the subsonic range (lower than 20 Hz), capable of effectively measuring and catching low-frequency fluctuations.

Furthermore, the tube body of the low-frequency extension tube of the present invention may be a spiral tube, reducing the length of the tube body in a longitudinal direction, and improving use convenience.

Although the present disclosure has been disclosed as above in the form of embodiments, it is not intended to limit the present disclosure. Anyone with ordinary knowledge in the technical field may make some modifications without departing from the spirit and scope of the present disclosure, so the scope of protection of this disclosure shall be subject to the scope of the patent application attached.

What is claimed is:

1. A pipeline fluid pressure fluctuation sensing device, adapted to connect a fluid pipeline, said pipeline fluid pressure fluctuation sensing device comprising:
a housing, comprising an open end and closed end opposite to each other, wherein said open end is adapted to connect said fluid pipeline;
a vibrating membrane, provided inside said housing, said vibrating membrane allowed to be displaced due to a pressure change generated by said fluid pipeline;
a fixing ring, connected between said housing and vibrating membrane;
a pressure balance hole, passed through said fixing ring, and adapted to balance pressure at two opposite sides of said vibrating membrane;
a magnetic element, linked to said vibrating film, wherein said magnetic element is generated with a displacement change because said vibrating membrane is displaced; and
a magnetic sensing element, provided outside said housing, and said magnetic sensing element sensing said displacement change of said magnetic element.

2. The device according to claim 1, wherein the material of said vibrating membrane comprises an elastomer structure, Teflon structure, or metal structure.

3. The device according to claim 1, wherein said fixing ring has an inner peripheral surface and outer peripheral surface, said outer peripheral surface of said fixing ring is fixed to said housing, and said vibrating membrane is connected inside said inner peripheral surface of said fixing ring.

4. The device according to claim 1, further comprising:
a low-frequency extension tube, comprising a tube body, entrance end, and exit end.

5. The device according to claim 4, wherein said vibrating membrane allows said housing to be divided into an inner area and outer area, said low-frequency extension tube is positioned inside said inner area, said pressure balance hole comprises a first pressure balance hole and second pressure balance hole, said tube body is in connection with said fixing ring, and said second pressure balance hole is in communication with said entrance end.

6. The device according to claim 4, wherein said vibrating membrane allows said housing to be divided into an inner area and outer area, said low-frequency extension tube is provided outside said housing, said pressure balance hole comprises a first pressure balance hole and second pressure balance hole, said first pressure balance hole and second pressure hole are respectively passed through said housing, said first pressure balance hole is positioned in said outer area, said second pressure balance hole is positioned in said inner area, said entrance end is in communication with said first pressure balance hole in said outer area, and said exit end is in communication with said second pressure balance hole in said inner area.

7. The device according to claim 6, wherein said magnetic element is provided below said vibrating membrane, said housing includes a main body and recessed body, said recessed body is an accommodation space formed inward the bottom of said main body, and said magnetic sensing element is provided inside said recessed body.

8. The device according to claim 4, wherein said tube body is a spiral tube.

9. The device according to claim 4, further comprising:
an extension rod, connected between said vibrating membrane and magnetic element, said tube body provided on the outer periphery of said extension rod, said housing comprising a main body and extension body, said extension body in communication with said main body, a part of said magnetic element and extension rod positioned inside said extension body, and said magnetic sensing element positioned on the outer side of said extension body.

10. The device according to claim 9, wherein said extension rod is made of a non-magnetic material or magnetic material.

11. The device according to claim 1, wherein said magnetic element is provided below said vibrating membrane.

12. The device according to claim 1, wherein said housing is made of a non-magnetic material.
